(19) United States
(12) Patent Application Publication
(10) Pub. No.: US 2012/0049579 A1
(43) Pub. Date: Mar. 1, 2012

(54) ARTICULATING DOOR HINGE

(75) Inventors: Jeffrey L. Konchan, Romeo, MI (US); Gary W. Krajenke, Warren, MI (US); Gregory B. Smith, Algonac, MI (US)

(73) Assignee: GM GLOBAL TECHNOLOGY OPERATIONS, INC., Detroit, MI (US)

(21) Appl. No.: 12/873,578

(22) Filed: Sep. 1, 2010

(51) Int. Cl. B60J 5/04; E05D 7/00; E05F 1/12

(52) U.S. Cl. 296/202; 16/382

(57) ABSTRACT

A hinge assembly for a first door of a pair of opposing-hinged doors includes a curved extension, a first pivot connection interconnecting the curved extension and a body of the vehicle, and a second pivot connection interconnecting the curved extension and the first door. When opening the first door, a first edge of the first door pivots about the first pivot connection away from the body and draws a second edge of the door away from an adjacent second door. The first door pivots about the second pivot connection to open the first door independently of the adjacent second door.

### TECHNICAL FIELD

The invention generally relates to a vehicle having opposing-hinged doors, and more specifically to a hinge assembly for one of the opposing-hinged doors.

### BACKGROUND

Opposing-hinged doors on vehicles include a first door and a second door, and may be arranged on the same side of the vehicle, longitudinally adjacent to each other. Each of the opposing-hinged doors pivots open in an opposite direction. More specifically, the first door includes a forward edge disposed nearer a first end of the vehicle and a rearward edge disposed nearer a second end of the vehicle. The first door is hinged along the rearward edge of the first door, and pivots open in a first pivot direction such that the forward edge of the first door swings away from the vehicle when opening the first door and toward the vehicle when closing the first door. The second door also includes a forward edge disposed nearer the first end of the vehicle and a rearward edge disposed nearer the second end of the vehicle. The second door is hinged along the forward edge of the second door, and pivots in a second pivot direction, which is opposite the first pivot direction, such that the rearward edge of the second door swings away from the vehicle when opening the second door and toward the vehicle when closing the second door. Accordingly, the first door and the second door open and close in opposite directions.

Opposing-hinged doors may not include a body pillar disposed between the first door and the second door, thereby defining a “continuous”, i.e., uninterrupted, opening. When no body pillar exists between the first door and the second door, the first door and the second door are arranged immediately adjacent each other in sealing engagement. Typically, the opposing-hinged doors are arranged such that the more forward door, i.e., the second door, must be opened prior to and in order to open the more rearward door, i.e., the first door. In other words, opening the more rearward first door is dependent upon opening the more forward second door beforehand.

### SUMMARY

A vehicle is provided. The vehicle includes a body and a first door. The first door includes a first edge and a second edge. The second edge is spaced from the first edge. The first door is moveable between a closed position, an intermediate position and an open position. The vehicle further includes a hinge assembly that pivotably couples the first door to the body. The hinge assembly includes a curved extension having a first end and a second end. The hinge assembly further includes a first pivot connection and a second pivot connection. The first pivot connection pivotably interconnects the first end of the curved extension and the body. The second pivot connection pivotably interconnects the second end of the curved extension and the second edge of the first door. The curved extension pivots about the first pivot connection into a pivot position when moving from the closed position into the intermediate position. The curved extension pivots about the first pivot connection to move the second edge of the first door laterally away from the body, and to move the first edge of the first door parallel with the body. The first door pivots about the second pivot connection in a first direction when moving from the intermediate position into the open position. The first door pivots about the second pivot connection to swing the first edge of the first door laterally away from the body.

A hinge assembly for pivotably coupling a first door to a body of a vehicle is also provided. The hinge assembly includes a curved extension having a first end and a second end. A first pivot connection is configured for pivotably interconnecting the first end of the curved extension and the body. A second pivot connection is configured for pivotably interconnecting the second end of the curved extension and the first door. The curved extension pivots about the first pivot connection into a pivot position to move the first door laterally away from and parallel with the body. The first door pivots about the second pivot connection in a first direction to move into an open position.

Accordingly, movement from the closed position into the intermediate position moves the second edge of the first door laterally away from the body, which simultaneously draws the first edge of the first door along and parallel with the longitudinal axis of the body. This movement into the intermediate position from the closed position allows the first door to move longitudinally away from a second door. Once in the intermediate position, the first door is free to rotate into the open position. Accordingly, the first door may open independently of the second door.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of a vehicle.

FIG. 2 is a schematic fragmentary plan view of the vehicle showing the first door in a closed position.

FIG. 3 is a schematic fragmentary plan view of the vehicle showing the first door in an intermediate position.

FIG. 4 is a schematic fragmentary plan view of the vehicle showing the first door in an open position.

FIG. 5 is a schematic perspective view of a first door of the vehicle.

FIG. 6 is a schematic perspective view of a hinge assembly of the vehicle.

### DETAILED DESCRIPTION

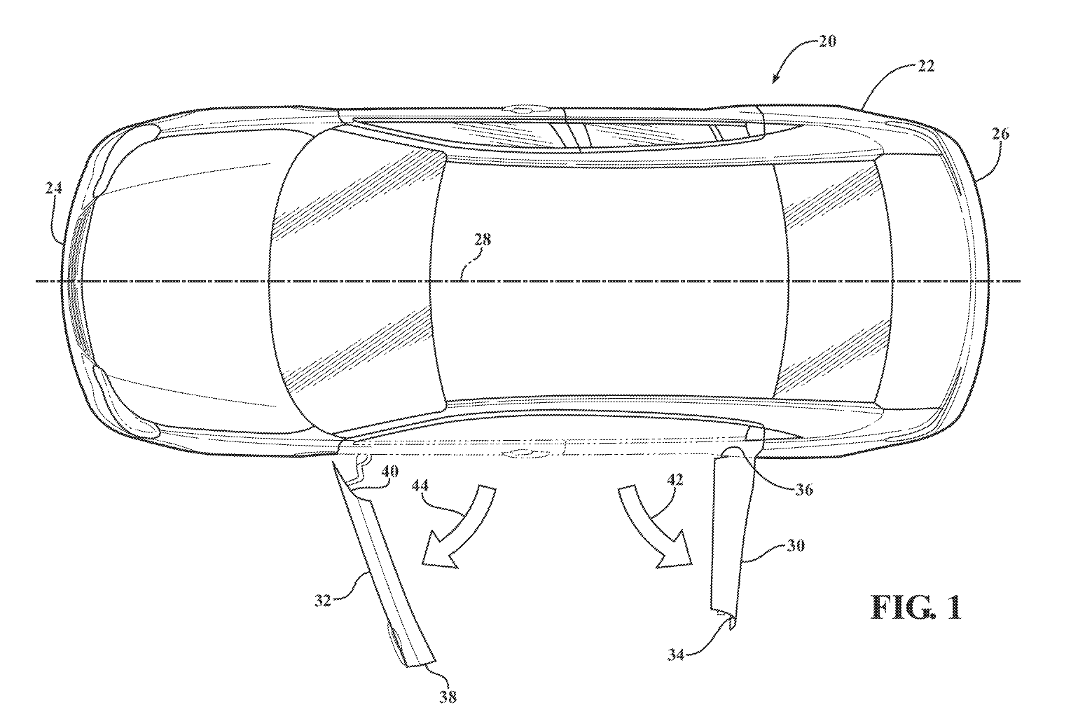

Referring to the Figures, wherein like numerals indicate like parts throughout the several views, a vehicle is shown generally at 20 in FIG. 1. Referring to FIG. 1, the vehicle 20 includes a body 22, and a pair of opposing hinged doors. The body 22 may include a frame and any structural support elements attached thereto, as well as the outer sheet metal coverings attached to the frame and/or structural elements of the vehicle 20.

The body 22 includes a first end 24 and a second end 26. The second end 26 of the body 22 is disposed opposite the first end 24 along a longitudinal axis 28 of the body 22. As shown, the first end 24 of the vehicle 20 includes a front of the vehicle 20. However, the first end 24 of the vehicle 20 is not limited to the front of the vehicle 20. As shown, the second end 26 includes a back end of the vehicle 20. However, the second end 26 of the vehicle 20 is not limited to the back of the vehicle 20. The longitudinal axis 28 extends between the first end 24 and the second end 26 of the vehicle 20.

The pair of opposing hinged doors includes a first door 30 and a second door 32. The first door 30 and the second door 32 are disposed on the same side of the vehicle 20, adjacent each other, and open in opposite directions, away from each other to provide a continuous, i.e., unobstructed, opening into an interior compartment of the vehicle 20. The first door 30 and the second door 32 are “opposing hinged doors” because the first door 30 and the second door 32 pivot open in opposite directions. The opposing hinged doors allow for the continuous opening defined by the body 22, with no B-pillar disposed between the first door 30 and the second door 32. The first door 30 and the second door 32 are independently openable and closeable, i.e., may be opened and closed in either order or simultaneously. Because the opening defined by the body 22 is continuous, with no B-pillar between the first door 30 and the second door 32, the first door 30 and the second door 32 define a joint therebetween that should be sealed.

As shown, the first door 30 is disposed nearer the second end 26 of the body 22 than the second door 32, and the second door 32 is disposed nearer the first end 24 of the body 22 than the first door 30. However, it should be appreciated that the positions of the first door 30 and the second door 32 relative to the first end 24 and the second end 26 of the vehicle 20 may be reversed from that shown in the Figures. Additionally, while the first door 30 and the second door 32 are shown in the Figures as passenger access doors on a side of the vehicle 20, it should be appreciated that the first door 30 and the second door 32 may be positioned elsewhere on the vehicle 20, and may include any type of closure panels, including but not limited to rear cargo doors of a cargo van.

The first door 30 includes a first edge 34 extending substantially vertically and a second edge 36 extending substantially vertically and spaced from the first edge 34. The second edge 36 of the first door 30 is disposed opposite the first edge 34 along the longitudinal axis 28 of the body 22. Accordingly, the first edge 34 and the second edge 36 of the first door 30 define a forward edge and a rearward edge of the first door 30. As shown, the first edge 34 of the first door 30 is disposed nearer the first end 24 of the body 22 than the second edge 36 of the first door 30, and the second edge 36 of the first door 30 is disposed nearer the second end 26 of the body 22 than the first edge 34 of the first door 30. However, it should be appreciated that the positions of the first edge 34 and the second edge 36 of the first door 30 may be reversed from that shown in the Figures.

The second door 32 is pivotably attached to the body 22. The second door 32 includes a first edge 38 and a second edge 40. The first edge 38 of the second door 32 is disposed opposite the second edge 40 along the longitudinal axis 28 of the body 22. Accordingly, the first edge 38 and the second edge 40 of the second door 32 define a forward edge and a rearward edge of the second door 32. As shown, the first edge 38 of the second door 32 is disposed nearer the second end 26 of the body 22 than the second edge 40 of the second door 32, and the second edge 40 of the second door 32 is disposed nearer the first end 24 of the body 22 than the first edge 38 of the second door 32. However, it should be appreciated that the positions of the first edge 38 and the second edge 40 of the second door 32 may be reversed from that shown in the Figures.

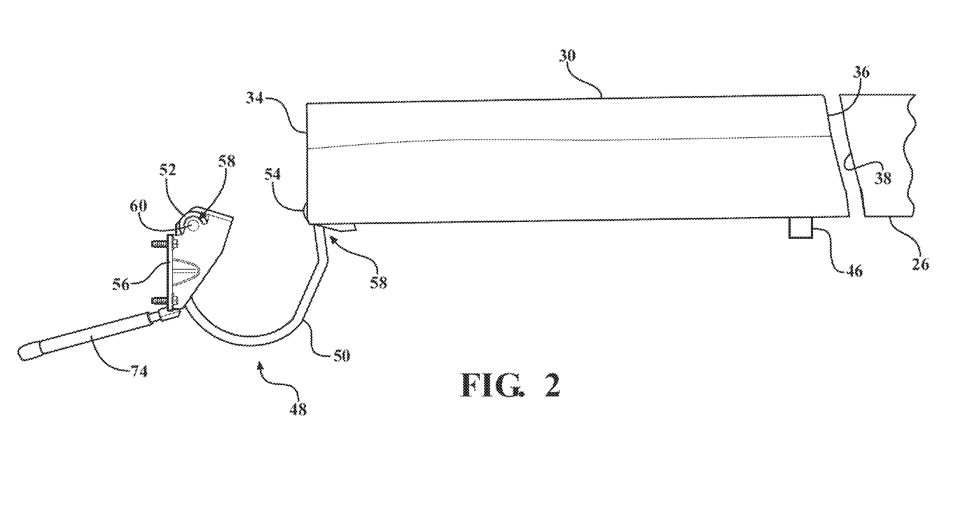

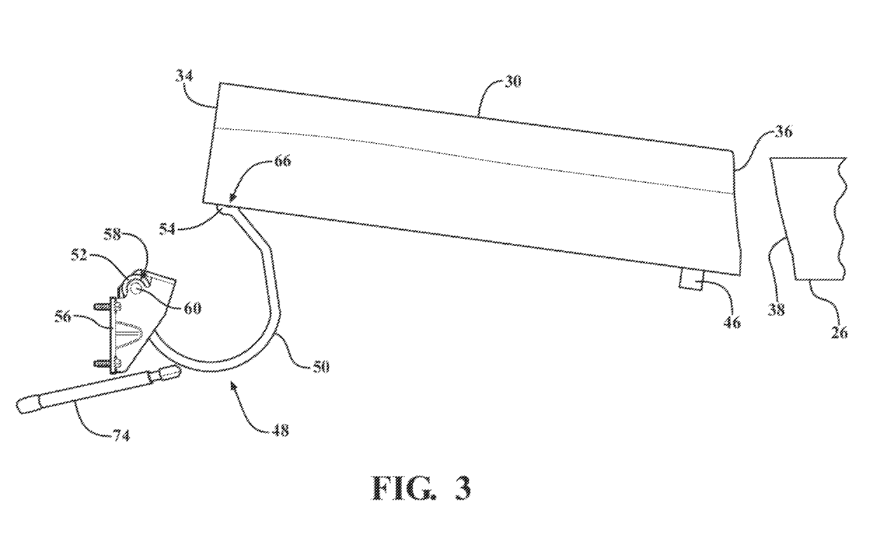

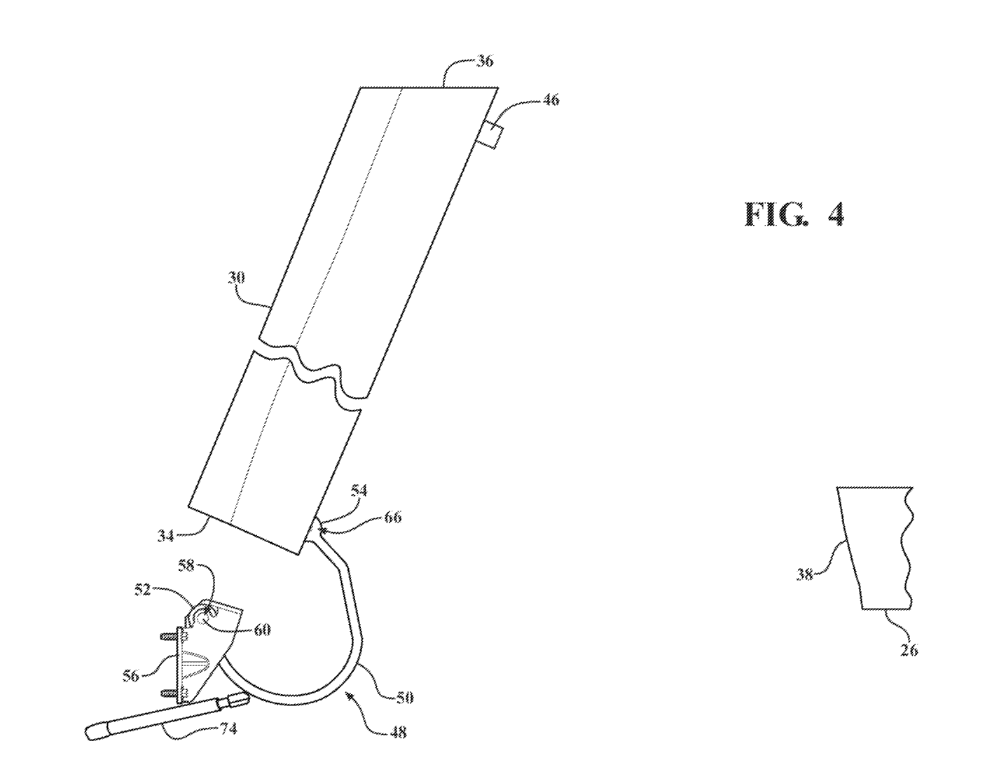

Referring also to FIGS. 2 through 4, the first door 30 is moveable between a closed position, shown in FIG. 2, an intermediate position, shown in FIG. 3, and an open position, shown in FIG. 4. The first door 30 pivots into the open position in a first pivot direction 42. The second door 32 pivots open in a second pivot direction 44. The second pivot direction 44 is opposite the first pivot direction 42. The first pivot direction 42 includes one of a counterclockwise direction and a clockwise direction, and the second pivot direction 44 includes the other of the counterclockwise direction and the clockwise direction.

The first door 30 moves from the closed position, into the intermediate position, and then into the open position in succession when opening the first door 30. The first door 30 moves from the open position, into the intermediate position, and then into the closed position in succession when closing the first door 30. When the first door 30 is in the closed position, the first door 30 is disposed substantially parallel with the longitudinal axis 28 of the body 22. To open the first door 30, the first door 30 moves from the closed position into the intermediate position. When the first door 30 moves from the closed position into the intermediate position, the second edge 36 of the first door 30 moves laterally relative to the longitudinal axis 28 of the body 22, away from the body 22 and into a pivot position. Additionally, the first edge 34 of the first door 30 moves parallel with the longitudinal axis 28, away from the second door 32 when the first door 30 moves from the closed position into the intermediate position.

The pivot position is the position the second edge 36 of the first door 30 must be in relative to the body 22 to allow the first door 30 to pivot open and closed, without interfering with the second door 32 and/or the body 22, and to avoid damaging any seals disposed between the first door 30 and the second door 32.

In order to ensure that the first door 30 pivots into the open position only when the hinge assembly is in the pivot position, the first door 30 includes a latch mechanism 46. The latch mechanism 46 is attached to the first door 30 adjacent the first edge 34 of the first door 30. The latch mechanism 46 prevents lateral movement of the first edge 34 of the first door 30 away from the body 22 when the first door 30 is in the closed position or the intermediate position, or is disposed between the closed position and the intermediate position. The latch mechanism 46 engages the first door 30 in interlocking engagement when the first door 30 moves from the open position into the intermediate position. Accordingly, once the first door 30 is moved into the intermediate position, the latch mechanism 46 latches the first edge 34 of the first door 30, thereby allowing the first door 30 to move into the closed position without swinging laterally away from the body 22 and damaging the second door 32. The latch mechanism 46 may include any type, size, style and/or configuration of latch suitable for use on a closure panel and capable of preventing lateral movement of the first edge 34 of the first door 30 away from the body 22 and moveable with the first edge 34 of the first door 30 between the closed position and the intermediate position. Accordingly, the latch mechanism 46 is not described in detail herein.

Once the first door 30 moves into the intermediate position from the closed position, the latch mechanism 46 is disengaged to allow pivotal movement of the first edge 34 of the first door 30 about a second pivot axis 70 (described in greater detail below) and into the open position. When the first door 30 moves from the intermediate position into the open position, the first door 30 pivots about the second pivot axis 70 such that the first edge 34 of the first door 30 swings laterally away from the body 22. To close the first door 30, the steps described above for opening the first door 30 are executed in reverse order. In this manner, the first door 30 is moveable between the closed position, the intermediate position and the open position independently of the second door 32.

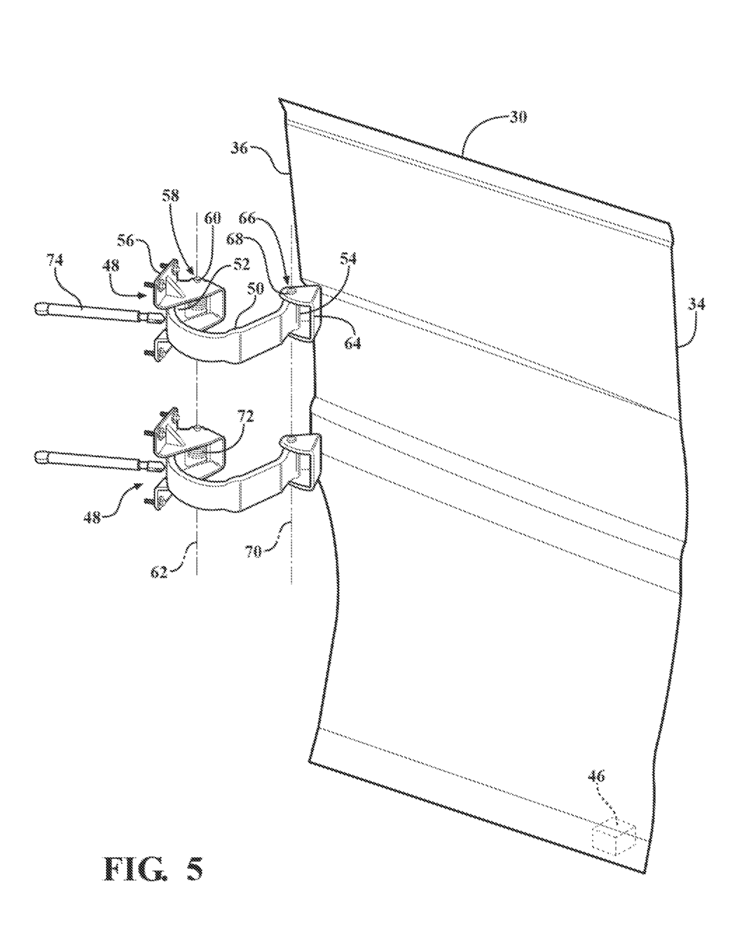

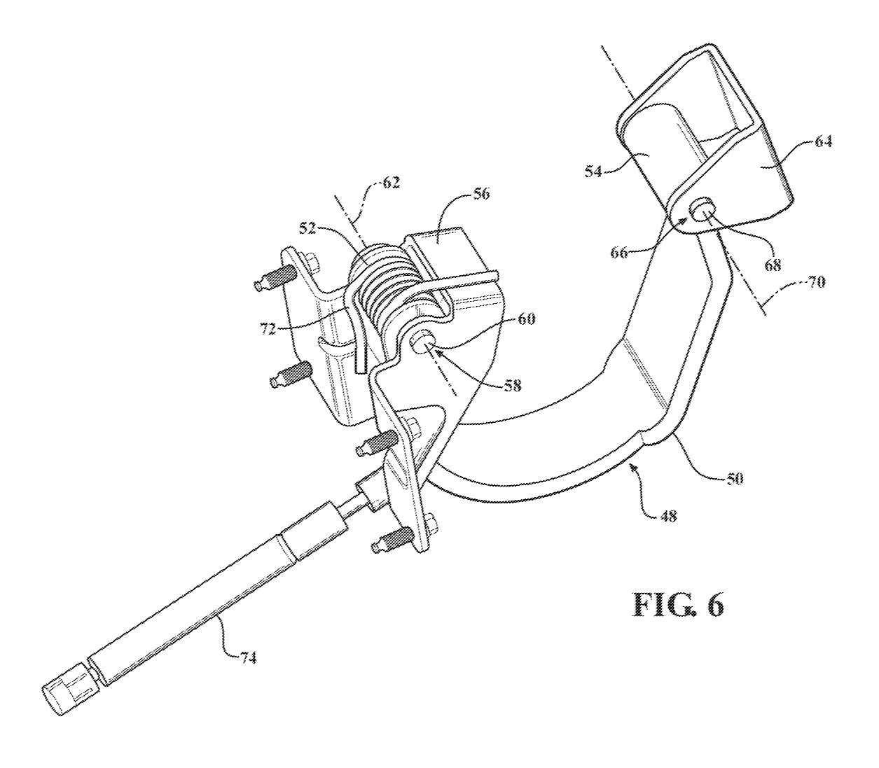

Referring to FIGS. 5 and 6, a hinge assembly pivotably couples the first door 30 to the body 22. As shown, two identical hinge assemblies 48 pivotably couple the first door 30 to the body 22. It should be appreciated that the vehicle 20 may include any number of hinge assemblies 48 pivotably coupling the first door 30 to the body 22. The hinge assembly includes a curved extension 50. The curved extension 50 includes a first end 52 and a second end 54. The hinge assembly further includes a first bracket 56 pivotably coupled to the first end 52 of the curved extension 50 to define a first pivot connection 58. The first pivot connection 58 pivotably interconnects the first end 52 of the curved extension 50 and the body 22. A first pin 60 interconnects the first bracket 56 and the first end 52 of the curved extension 50. The first pin 60 defines a first pivot axis 62, about which the curved extension 50 rotates relative to the body 22. The curved extension 50 pivots about the first pivot axis 62 of the first pivot connection 58 into the pivot position when moving from the closed position into the intermediate position. The pivotal movement of the curved extension 50 about the first pivot axis 62 moves the second edge 36 of the first door 30 laterally away from the body 22 and parallel with the body 22. The pivotal movement of the curved extension 50 about the first pivot axis 62 also moves the first edge 34 of the first door 30 parallel with the body 22, and away from the second door 32.

The hinge assembly further includes a second bracket 64 pivotably coupled to the second end 54 of the curved extension 50 to define a second pivot connection 66. The second pivot connection 66 pivotably interconnects the second end 54 of the curved extension 50 and the second edge 36 of the first door 30. A second pin 68 interconnects the second bracket 64 and the second end 54 of the curved extension 50 and defining the second pivot axis 70. The first door 30 pivots about the second pivot connection 66 in the first pivot direction 42 when moving from the intermediate position into the open position. The pivotal movement of the first door 30 about the first pivot axis 62 swings the first edge 34 of the first door 30 laterally away from the body 22.

The first pivot axis 62 is parallel with the second pivot axis 70, and spaced from the second pivot axis 70. The curved extension 50 includes a non-linear shape extending between the first pivot axis 62 and the second pivot axis 70. The non-linear shape of the curved extension 50 may be commonly described as a gooseneck shape. However, the non-linear shape may include any shape capable of moving the second end 54 of the curved extension 50 laterally away from body 22 while simultaneously moving the first edge 34 of the first door 30 longitudinally away from the second door 32 in response to pivotal movement about the first pivot axis 62.

The hinge assembly further includes a biasing device 72 that is coupled to the first bracket 56 and the first end 52 of the curved extension 50. The biasing device 72 is configured for biasing the curved extension 50 into the pivot position. The biasing device 72 may include but is not limited to a torsion spring or the like.

The vehicle 20 includes an actuator 74 that interconnects the body 22 and the curved extension 50. The actuator 74 is configured to move the curved extension 50 from the pivot position into a stowed position. The stowed position is the position of the curved extension 50 when the door is in the closed position. Accordingly, the actuator 74 draws the first door 30 into the closed position. The actuator 74 may be linked to the latch mechanism 46 so that the actuator 74 only draws the curved extension 50 into the stowed position when the latch mechanism 46 is engaged to prevent laterally movement of the first edge 34 of the door away from the body 22. The actuator 74 may include, but is not limited to, an electro-mechanical device. The electro-mechanical device may include, but is not limited to, an electrically powered geared actuator 74, an electrically operated smart material actuator 74, or some other similar device.

While the best modes for carrying out the invention have been described in detail, those familiar with the art to which this invention relates will recognize various alternative designs and embodiments for practicing the invention within the scope of the appended claims.

1. A vehicle comprising:
a body;
a first door having a first edge and a second edge spaced from the first edge, wherein the first door is moveable between a closed position, an intermediate position and an open position; and
a hinge assembly pivotably coupling the first door to the body, the hinge assembly including:
a curved extension having a first end and a second end;
a first pivot connection pivotably interconnecting the first end of the curved extension and the body; and
a second pivot connection pivotably interconnecting the second end of the curved extension and the second edge of the first door;
wherein the curved extension pivots about the first pivot connection into a pivot position when moving from the closed position into the intermediate position to move the second edge of the first door laterally away from the body and to move the first edge of the first door parallel with the body; and
wherein the first door pivots about the second pivot connection in a first direction when moving from the intermediate position into the open position to swing the first edge of the first door laterally away from the body.

2. A vehicle as set forth in claim 1 wherein the hinge assembly includes a first bracket pivotably coupled to the first end of the curved extension to define the first pivot connection.

3. A vehicle as set forth in claim 2 wherein the hinge assembly includes a first pin interconnecting the first bracket and the first end of the curved extension and defining a first pivot axis.

4. A vehicle as set forth in claim 2 wherein the hinge assembly includes a biasing device coupled to the first bracket and the first end of the curved extension and configured for biasing the curved extension into the pivot position.

5. A vehicle as set forth in claim 4 wherein the biasing device includes a torsion spring.

6. A vehicle as set forth in claim 3 wherein the hinge assembly includes a second bracket pivotably coupled to the second end of the curved extension to define the second pivot connection.

7. A vehicle as set forth in claim 6 wherein the hinge assembly includes a second pin interconnecting the second bracket and the second end of the curved extension and defining a second pivot axis.

8. A vehicle as set forth in claim 7 wherein the first pivot axis is parallel with the second pivot axis, and wherein the curved extension includes a non-linear shape extending between the first pivot axis and the second pivot axis.

9. A vehicle as set forth in claim 6 further comprising an actuator interconnecting the body and the curved extension and configured to move the curved extension from the pivot position into a stowed position.

10. A vehicle as set forth in claim 9 wherein the actuator includes an electro-mechanical device.

11. A vehicle as set forth in claim 9 further comprising a latch mechanism disposed adjacent the first edge of the first door and configured for restricting lateral movement of the first edge of the first door away from the vehicle when the first door is in the closed position or moving between the closed position and the intermediate position, wherein the actuator engages the first door in interlocking engagement when the first door moves from the open position into the intermediate position.

12. A vehicle as set forth in claim 11 wherein the actuator moves the curved extension from the pivot position into the stowed position to move the first door into the closed position upon the latch mechanism engaging the first door in interlocking engagement when the first door moves from the open position into the intermediate position.

13. A vehicle as set forth in claim 1 further comprising a second door disposed adjacent the first door and pivotably attached to the body for pivotable movement in a second direction opposite the first direction, wherein movement of the first door from the closed position into the intermediate position moves the first door away from the second door.

14. A hinge assembly for pivotably coupling a first door to a body of a vehicle, the hinge assembly comprising:
a curved extension having a first end and a second end;
a first pivot connection configured for pivotably interconnecting the first end of the curved extension and the body; and
a second pivot connection configured for pivotably interconnecting the second end of the curved extension and the first door;
wherein the curved extension pivots about the first pivot connection into a pivot position to move the first door laterally away from and parallel with the body; and
wherein the first door pivots about the second pivot connection in a first direction to move into an open position.

15. A hinge assembly as set forth in claim 14 further comprising a first bracket pivotably coupled to the first end of the curved extension to define the first pivot connection.

16. A hinge assembly as set forth in claim 15 further comprising a first pin interconnecting the first bracket and the first end of the curved extension and defining a first pivot axis.

17. A hinge assembly as set forth in claim 15 further comprising a biasing device coupled to the first bracket and the first end of the curved extension and configured for biasing the curved extension into the pivot position.

18. A hinge assembly as set forth in claim 16 further comprising a second bracket pivotably coupled to the second end of the curved extension to define the second pivot connection.

19. A hinge assembly as set forth in claim 18 further comprising a second pin interconnecting the second bracket and the second end of the curved extension and defining a second pivot axis.

20. A hinge assembly as set forth in claim 19 wherein the first pivot axis is parallel with the second pivot axis, and wherein the curved extension includes a non-linear shape extending between the first pivot axis and the second pivot axis.
